(19) United States
(12) Patent Application Publication
(10) Pub. No.: US 2012/0298077 A1
(43) Pub. Date: Nov. 29, 2012

(54) OPPOSED PISTON ENGINE WITH GAS EXCHANGE CONTROL BY MEANS OF HYDROSTATICALLY MOVED SLIDING SLEEVES

(76) Inventors: Günter Elsbett, Roth (DE); Otto Daude, Hambuhren (DE)

(21) Appl. No.: 13/510,842

(22) PCT Filed: Nov. 16, 2010
(86) PCT No.: PCT/EP10/67579

§ 371 Date: Aug. 10, 2012

(30) Foreign Application Priority Data
Nov. 18, 2009 (DE) 10 2009 053 723.6
Nov. 18, 2009 (DE) 20 2009 017 700.9

(51) Int. Cl. F01L 5/06; F02B 75/28

(52) U.S. Cl. 123/51 R

(57) ABSTRACT

An opposed piston engine with gas exchange control using sliding sleeves embodied on their outer periphery as differential pistons that can be operated as slave pistons. A plunger that is displaceable by a cam is used as a master piston. A hydraulic liquid is housed between the master piston and the slave piston in a closed pipe system. The liquid column housed between the master piston and the slave piston can be displaced back and forth by hydrostatic pressure build-up enabling the gas exchange elements to be opened and closed by the sliding sleeves.

The invention is suitable in particular for use in opposed piston engines. These operate in general in the two-stroke process. In this, two pistons move counter to one another in a common cylinder, at the two ends of which are arranged crankshafts that are synchronised via a corresponding gear mechanism and that convert the stroke movements of the pistons in a known manner via connecting rods and crankpins into a rotational movement.

The gas exchange takes place in this connection through the pistons, which in the stroke region of their lower dead centres free inlet and outlet openings, through which the fresh gas can flow into the cylinder before the combustion and the exhaust gas can flow out of the cylinder after the combustion. Since this cycle is repeated with each rotation of the crankshaft, a four-stroke process cannot be accomplished in this way. In addition there is the disadvantage that the oil film on the cylinder wall necessary for lubrication is stripped by the pistons and their piston rings in the overrunning of the control openings into these slits. This results in increased oil consumption and poor emissions.

It is known (DE-A-1906542) to control the gas exchange in internal combustion engines by means of sliding sleeves. It is also known (DE202005021624U1 and DE202006020546U1) to avoid a slit overrunning of the pistons in opposed piston engines by means of such sliding sleeves controlling the gas exchange. In this connection arbitrary control times can be achieved in the two-stroke process as well as in the four-stroke process. In order to be able to utilise these advantages a simple and reliable drive for the sliding sleeves is required. A direct mechanical drive via control cams needs in this case two camshafts; one each for the inlet sleeve and the outlet sleeve. This requires a corresponding gearwheel mechanism for the camshafts, which should be positioned as close as possible to the sliding sleeves being driven in order to permit a direct, smooth and low vibration actuation. Such an arrangement is not always easy to implement and requires a complicated gear mechanism, in particular for the four-stroke method, since in this case the cam drive runs at half the rotational speed of the crankshaft and therefore requires large driving gears. The sliding sleeve is not accessible at arbitrary points for a mechanical actuation and the application of the sliding forces to the sliding sleeve must also take place as a rule unilaterally and therefore leads to deformations of the sliding sleeve, whose wall thickness is generally relatively thin for weight reasons.

The object of the invention is accordingly to simplify the drive of the sliding sleeves and to avoid the aforementioned complications.

This object is achieved according to the invention in that the sliding sleeves are hydrostatically actuated and the control is effected only by a camshaft arranged at an arbitrary point. The sliding sleeve is conveniently designed as a hollow hydraulic piston and comprises a pressure stage such as a stepped piston at any desired and convenient point on its outside. This pressure stage is formed by two concentric but different external diameters. The hydraulic pressure thus acts on the front surface between the two diameters. The cylinder bore guiding the sliding sleeve in the engine housing also comprises this pressure stage. This construction has the advantage that the lateral force action on the sliding sleeve takes place uniformly and without unilateral deformation. Both the opening and sliding movements of the sliding sleeve can thus be effected by hydrostatic pressure. It is however also envisaged that only the opening movement takes place hydrostatically and the closure of the sliding sleeves is effected with one or more springs, in the same way as takes place with inlet and outlet valves in conventional internal combustion engines.

The stroke movement of the sliding sleeve is initiated by the inlet and outlet cams located on the camshaft. The camshaft is advantageously arranged centrally, i.e. in the middle between both crankshafts, in order to allow short hydraulics lines. A tappet actuated via lugs is formed as a pump piston and is guided in a pump cylinder. The lubricating oil that is in any case present in the engine serves as hydraulic fluid, which is fed to the pump from the oil sump of the engine. Complicated seals and the separation of the oil circulations are thereby avoided. Any leakages that occur remain within the engine. The oil for the hydrostatic actuation is led from the pump via a corresponding external or internal line system to the pressure stage of the sliding sleeve. The stroke of the sliding sleeve begins after the oil feed bore in the pump cylinder on the pump side is closed by the stroke of the pump piston and the space between the sliding sleeve and pump piston has been closed and a pressure can build up within the piston. At the end of the stroke the sliding sleeve is returned to the initial position by means of a spring force—or alternatively by a hydrostatic movement by means of an opposing cam—and in this way the liquid column consequently resists the movement of the piston pump. Any slight leakages during the actuation can then be replaced after opening the oil feed bore.

The control times, i.e. the beginning and end of the sliding sleeve stroke, are governed by the adjustment of the pump cylinder. In this connection the screw arrangement of the pump cylinder the permits the longitudinal adjustment and thus the time of the closure of the oil feed bore.

The arrangement according to the invention also permits variable control times, in which—similar to the case of injection pumps—the pump cylinder can rotate and has an inclined control edge. Alternatively the pump cylinder can also be rotated or can execute a longitudinal movement.

The shape of the cam differs from conventional cam profiles in that a prestroke phase has to be factored in, in which the pump piston covers the path up to the closure of the oil feed bore. Similarly and in a known manner as with the often conventional hydraulic tappets in valve-controlled internal combustion engines, an automatic play compensation thus takes place. An alternative implementation of this actuation of the gas exchange control is obtained by incorporating a non-return valve in the oil feed to the pump element. This non-return valve allows only that amount of hydraulic fluid to flow in that was lost by leakage in the preceding tappet stroke. A prestroke is avoided in this way.

In principle the hydrostatic sleeve movement can take place in both directions. It is however advantageous—similar to the case in conventional valve controls in internal combustion engines—to effect the return of the sliding sleeve by means of a spring force. In this way a play-free closure of the sliding sleeve on its sealing seat is ensured, and in addition a further oil circulation to actuate the closure stroke—including further cams and tappets—is avoided. The opening and closing stroke are controlled by a single cam.

As a rule the lubricating oil that is in any case present in the engine should be used as hydraulic medium. In this way the effort involved in sealing all control components becomes very small, since slight leakages are not damaging and these are recycled to the general oil circulation.

### DESCRIPTION OF THE FIGURES

FIG. 1 shows a cross-section through an opposed piston engine. Two pistons 1 and 2 move counter to one another in an engine housing consisting of two crank housings 3 and 4 and two cylinder halves 5 and 6 that are connected to one another by a cylinder middle part 7. The pistons are driven by two crankshafts 8 and 9, as well as by the connecting rods 10 and 11. Their movement is synchronised by a gear drive 12. The central gear of this gear drive is mounted in a control housing 13 secured on the cylinder middle part 7 of the engine housing and rotates at half the crankshaft rotational speed in the four-stroke process. It drives a camshaft 14, which comprises a cam for actuating an injection pump 15, as well as a cam for controlling the gas exchange of the inlet and outlet by means of the sliding sleeves 16 and 17. Due to their displacement the annular gas channels 18 and 19 can be opened and closed independently of one another.

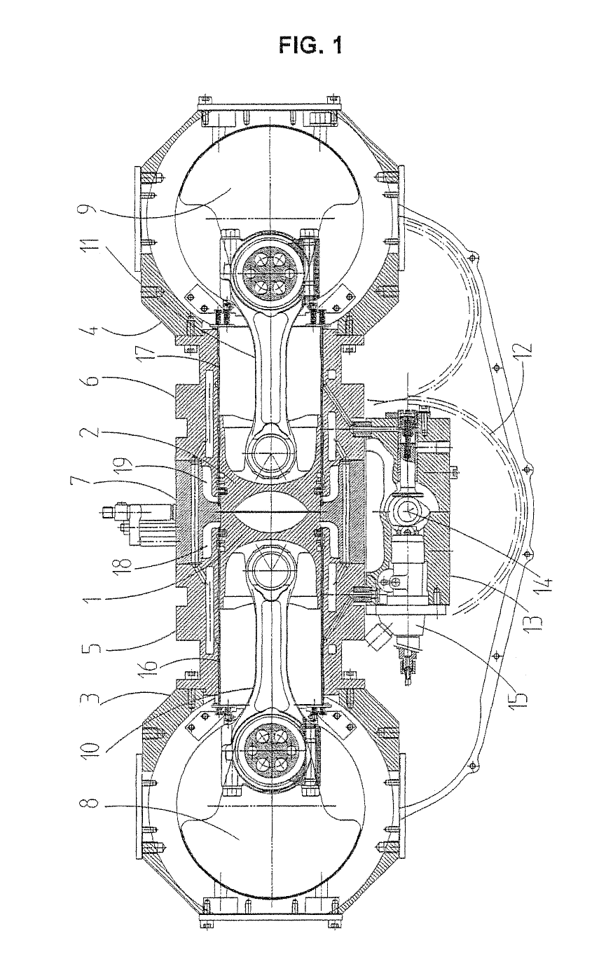

FIG. 2 shows more details of FIG. 1, in which only one half of the cross-section is illustrated. A tappet 20 guided in the control housing 13, and which is forced by a spring 21 against a cam 22, executes a reciprocatory movement due to the rotation of the camshaft 14. The tappet 20 is at the same time used as a pump piston. The space 24 behind the tappet 20, as well as the lines 25 and 26, are filled through an oil feed bore 23. These lines lead the oil into a surrounding annular groove 27, which runs around the external diameter of the sliding sleeve 17 in the region of a shoulder 28. This shoulder is formed in that, on the external circumference of the sliding sleeve 17 the side facing forwards the crankshaft 9 has a larger diameter than the side facing towards the cylinder middle part 7. In this way the sliding sleeve 17 can be moved by application of pressure, like a differential piston. As soon as the oil feed bore 23 in the control housing 13 is now closed by the stroke movement of the tappet 20, an excess pressure builds up in the liquid column in the space 24, in the lines 25 and 26, as well as in the annular groove 27, which displaces the sliding sleeve 17 and thereby opens the gas channel 19. The closure movement is executed by springs 29, which following the downward movement of the cam 22 and tappet 20, restore the sliding sleeve 17 to its sealing seat 30. The leakages occurring during the sliding movement serve to lubricate the tappet 20 and sliding sleeve 17. The leakages are replaced by inflow of oil through the oil feed bore 23 as soon as this is reopened by the return movement of the tappet 20. The leakage from the tappet 20 flows into the control housing 13 and the leakage from the larger diameter of the sliding sleeve 17 flows into the crankcase 4. The leakage from the smaller diameter is collected in an annular groove 31 of the cylinder half 6 and from there is recycled to the circulation. The avoidance of outflow of oil into the gas channel 19 is ensured by a piston-shaped seal by means of one or more sealing rings 32.

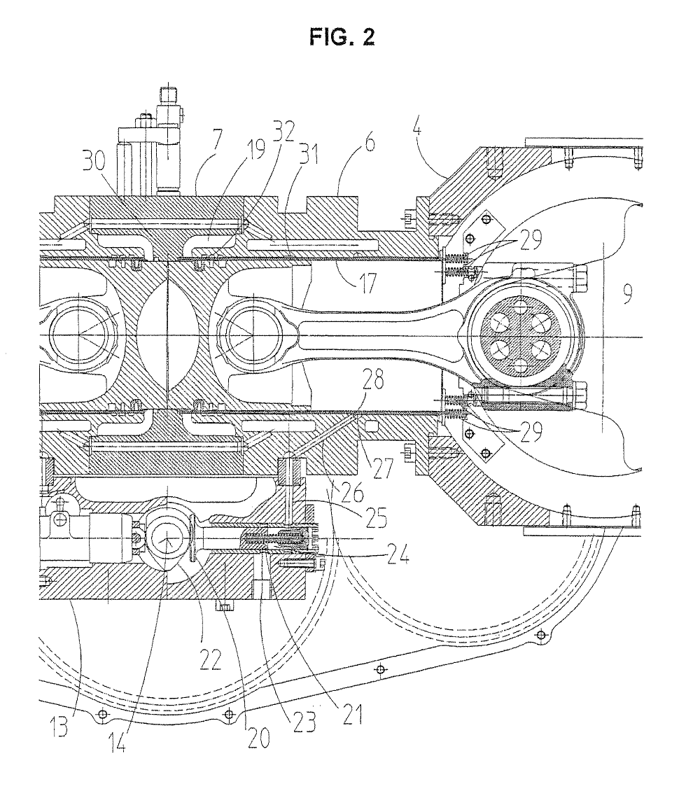

FIG. 3 shows more details of FIG. 2 in the region of the control housing 13. The tappet 20 is not directly guided in the control housing 13, but in a rotatable casing 33 that comprises at its outer end a screw thread 34 with engagement surfaces 35 for a key for its rotation. The thread 34 is screwed to a plate 36 secured to the control housing 13. The oil fed through the oil feed bore 23 passes through holes 37 in an outer groove 38 into an inner groove 39 of the casing 33. The hydrostatic build-up of pressure in the liquid column leading to the sliding sleeve begins once this internal groove 39 is closed by the initial stroke of the tappet 20. An exact adjustment of this prestroke—and thereby a fine adjustment of the control time—can be carried out by rotating the casing 33 on its key engagement surfaces 35, since the prestroke can be altered corresponding to the pitch of the screw thread 34. An outer groove 40 prevents the further application of pressure through the holes 41 into the bore 25 being interrupted by the rotation of the casing 33. The adjustment device is sealed on the outside by the O-rings 42 and 43. The adjustment of the control times can of course also take place dynamically, in other words while the engine is running, with corresponding control modules, whereby variable control times can be achieved in a simple manner.

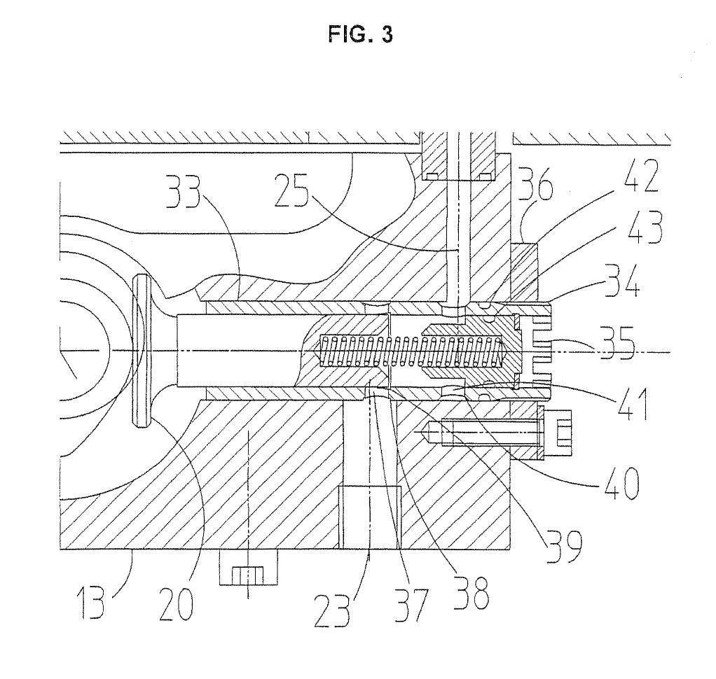

1. An opposed piston engine comprising:
sliding sleeves to control gas exchange, wherein each sliding sleeve includes a shoulder-shaped pressure stage on the external diameter thereof, the sliding sleeves being displaceable by application of a hydrostatic pressure.

2. The opposed piston engine according to claim 1, wherein the opening stroke of the sliding sleeves is effected by application of hydrostatic pressure and the closing stroke of the sliding sleeves is performed by a spring force acting on the sliding sleeves.

3. The opposed piston engine according to claim 1, wherein the application of the hydrostatic pressure is initiated by a piston designed as a tappet that is actuated by a cam.

4. The opposed piston engine according to claim 3, wherein adjustment of control times is carried out by a device that permits a variable prestroke that is an alterable stroke of the tappet up to the start of the pressure build-up.

5. The opposed piston engine according to claim 4, wherein the device for the adjustment of the control times is effected by a casing displaceable along the tappet axis, in which the tappet is guided and which includes inlet bores and inlet grooves, through which under a longitudinal displacement of the casing an alterable time of the start of the pressure build-up can be adjusted.

6. The opposed piston engine according to claim 5, wherein the longitudinal displacement of the casing is effected by rotation of a screw thread.

7. The opposed piston engine according to claim 6, wherein the casing displacement is also performed dynamically during operation of the engine to achieve variable control times.

8. The opposed piston engine according to claim 1, wherein only one camshaft is required for actuating an inlet sliding sleeve and an outlet sliding sleeve, the camshaft being mounted in a centrally arranged control housing, the camshaft including cams for actuating inlet and outlet tappets that are arranged in the control housing.

9. The opposed piston engine according to claim 8, wherein the camshaft mounted in the control housing includes injection cams in addition to the cams for the gas exchange control, and wherein one or more injection pumps are also installed in the control housing in addition to the inlet and outlet tappets.
